(19) United States
(12) Patent Application Publication
(10) Pub. No.: US 2022/0391780 A1
(43) Pub. Date: Dec. 8, 2022

(54) METHOD OF FEDERATED LEARNING, ELECTRONIC DEVICE, AND STORAGE MEDIUM

(71) Applicant: Beijing Baidu Netcom Science Technology Co., Ltd., Beijing (CN)

(72) Inventors: Ji LIU, Beijing (CN); Beichen MA, Beijing (CN); Chendi ZHOU, Beijing (CN); Juncheng JIA, Beijing (CN); Dejing DOU, Beijing (CN); Shilei JI, Beijing (CN); Yuan LIAO, Beijing (CN)

(21) Appl. No.: 17/820,758

(22) Filed: Aug. 18, 2022

(30) Foreign Application Priority Data
Sep. 18, 2021 (CN) 202111104028.6

(51) Int. Cl. G06N 20/20; G06F 9/48

(52) U.S. Cl. CPC G06N 20/20; G06F 9/4881

(57) ABSTRACT

The present disclosure provides a method of federated learning. A specific implementation solution includes: determining, for a current learning period, a target device for each task of at least one learning task to be performed, from a plurality of candidate devices according to a plurality of resource information of the plurality of candidate devices; transmitting a global model for the each task to the target device for the each task, so that the target device for the each task trains the global model for the each task; and updating, in response to receiving trained models from all target devices for the each task, the global model for the each task according to the trained models, so as to complete the current learning period. The present disclosure further provides an electronic device, and a storage medium.

### CROSS-REFERENCE TO RELATED APPLICATION(S)

This application claims the priority of Chinese Patent Application No. 202111104028.6, filed on Sep. 18, 2021, the entire contents of which are hereby incorporated by reference.

### TECHNICAL FIELD

The present disclosure relates to a field of an artificial intelligence technology, in particular to fields of distributed data processing and deep learning technologies, and more specifically, to a method of federated learning, an electronic device, a storage medium, and a computer program product.

### BACKGROUND

Federated learning is a distributed machine learning technology, in which a collaborative training is performed between a plurality of distributed edge devices or servers by using distributed data and computing resources. Federated learning does not need to share local raw data of devices, which may prevent a leakage of the local raw data of devices. In an example, a method is provided to improve an efficiency of Federated learning in a case of a single task, but how to improve the efficiency of Federated learning in a multi-task scenario is an urgent problem to be solved.

### SUMMARY

In view of this, the present disclosure provides a method of federated learning, an electronic device, and a storage medium.

According to an aspect of the present disclosure, a method of federated learning is provided, including: determining, for a current learning period, a target device for each task of at least one learning task to be performed, from a plurality of candidate devices according to a plurality of resource information of the plurality of candidate devices; transmitting a global model for the each task to the target device for the each task, so that the target device for the each task trains the global model for the each task; and updating, in response to receiving trained models from all target devices for the each task, the global model for the each task according to the trained models, so as to complete the current learning period.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of federated learning provided by the present disclosure.

According to another aspect of the present disclosure, a non-transitory computer-readable storage medium having computer instructions therein is provided, wherein the computer instructions are configured to cause a computer to implement the method of federated learning provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure.

FIG. 1 shows a schematic diagram of a system architecture in which a method and an apparatus of federated learning may be applied according to embodiments of the present disclosure.

FIG. 2 shows a flowchart of a method of federated learning according to embodiments of the present disclosure.

FIG. 3 shows a flowchart of determining a target device for each task of at least one learning task to be performed, from a plurality of candidate devices according to embodiments of the present disclosure.

FIG. 4 shows a schematic diagram of a method of federated learning according to embodiments of the present disclosure.

FIG. 5 shows a structural block diagram of an apparatus of federated learning according to embodiments of the present disclosure.

FIG. 6 shows a block diagram of an electronic device for implementing the method of federated learning according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In a case of multi-task, an efficiency of Federated learning may be improved by optimizing a server resource. For example, a network latency may be reduced by optimizing an allocation of tasks, so as to improve the efficiency of Federated learning. For another example, a convergence time may be reduced by optimizing CPU (Central Processing Unit), communication and other resources of the server, so as to improve the efficiency of Federated learning. For another example, a multi-task acceleration may be performed by means of a multi-task collaboration to solve problems of a high communication cost and a fault tolerance of distributed multi-task learning, so as to improve the efficiency of Federated learning.

In an example, only how to optimize the server resource is considered, and how to optimize a scheduling scheme of a device resource is not considered. The device resource is limited, and it is difficult to ensure that there are sufficient resources to run multiple tasks at the same time.

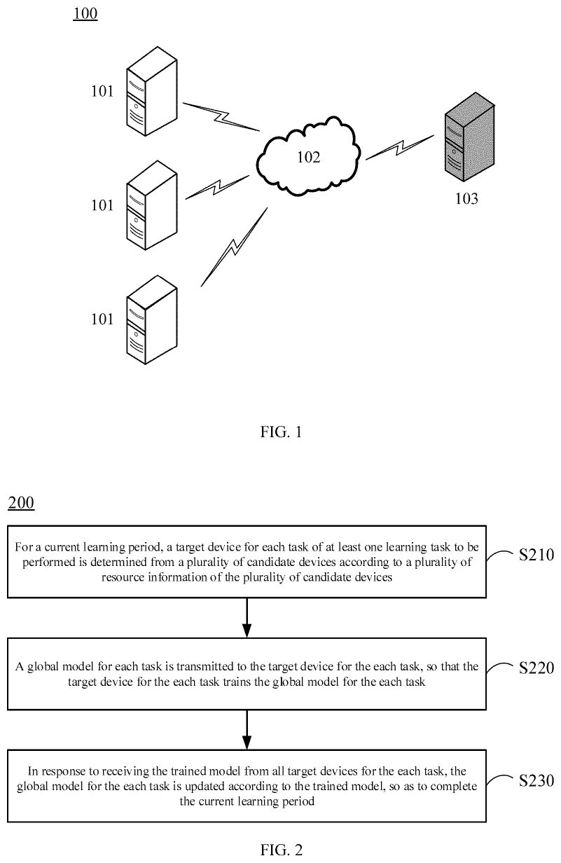

A system architecture for a method and an apparatus provided by the present disclosure will be described below with reference to FIG. 1.

FIG. 1 shows a schematic diagram of a system architecture for a method and an apparatus of federated learning according to embodiments of the present disclosure.

As shown in FIG. 1, a system architecture 100 according to this embodiment may include a plurality of devices 101, a network 102, and a server 103. The network 102 is a medium for providing a communication link between the devices 101 and the server 103. The network 102 may include various connection types, such as wired and/or wireless communication links, and the like.

A user may use the devices 101 to interact with the server 103 through the network 102 to receive or send messages, etc. The devices 101 may be various electronic devices, including but not limited to smart phones, tablet computers, laptop computers, and the like.

The method of federated learning provided by embodiments of the present disclosure may generally be performed by the server 103. Accordingly, the apparatus of federated learning provided by embodiments of the present disclosure may generally be arranged in the server 103. The method of federated learning provided by embodiments of the present disclosure may also be performed by a server or server cluster different from the server 103 and capable of communicating with the devices 101 and/or the server 103. Accordingly, the apparatus of federated learning provided by embodiments of the present disclosure may also be arranged in a server or server cluster different from the server 103 and capable of communicating with the devices 101 and/or the server 103.

In embodiments of the present disclosure, in a current learning period, the server 103 may assign a training task to different devices 101, for example, through the network 102. After performing a certain number of training, the plurality of devices 101 may return trained models to the server 103 through the network 102. The server 103 may update a parameter of a global model for the training task according to the trained models returned by different devices 101, so as to complete the training for the current learning period.

It should be understood that the number and type of devices 101, network 102 and server 103 in FIG. 1 are only schematic. According to implementation needs, any number and type of devices, networks and servers may be provided.

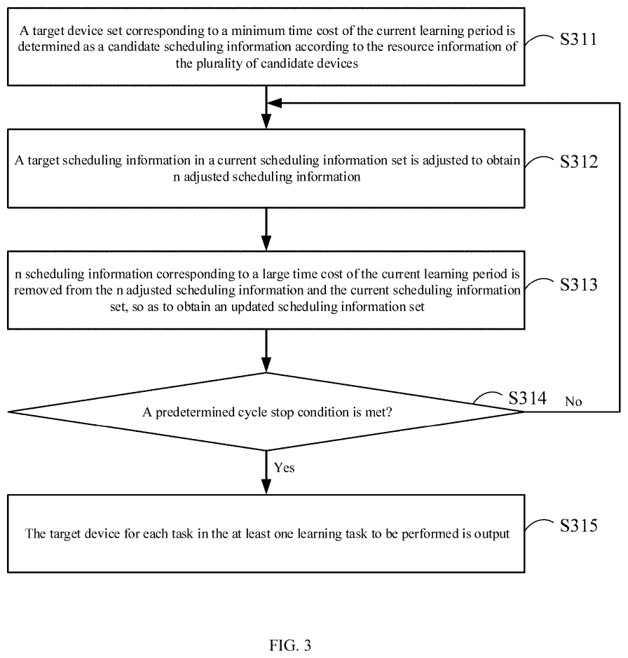

The method of federated learning provided by the present disclosure will be described in detail below through FIG. 2 to FIG. 4 in combination with FIG. 1.

FIG. 2 shows a flowchart of a method of federated learning according to embodiments of the present disclosure.

As shown in FIG. 2, a method 200 may include operation S210 to operation S230.

In operation S210, for a current learning period, a target device for each task of at least one learning task to be performed is determined from a plurality of candidate devices according to a plurality of resource information of the plurality of candidate devices.

For example, the at least one task to be performed may include a task of training at least one speech recognition model.

For example, the at least one task to be performed may include a task of training a speech recognition model, a task of training an image classification model, a task of training a text generation model, and so on.

In embodiments of the present disclosure, a plurality of learning periods may be run to perform the at least one learning task.

For example, 100 learning periods may be run to perform the task of training the speech recognition model.

For example, 200 learning periods may be run to perform the task of training the speech recognition model, the task of training the image classification model and the task of training the text generation model. It may take 100 learning periods to perform the task of training the speech recognition model, 120 learning periods to perform the task of training the image classification model, and 200 learning periods to perform the task of training the text generation model. In an example, the task of training the speech recognition model is no longer performed from a 101^{st} learning period.

In embodiments of the present disclosure, the number of at least one task to be performed may be fixed.

For example, only the task of training the speech recognition model, the task of training the image classification model and the task of training the text generation model may be performed.

In embodiments of the present disclosure, the number of at least one task to be performed may be dynamic.

For example, during the learning period, the task of training the speech recognition model, the task of training the image classification model and the task of training the text generation model may be performed. In an example, 200 learning periods may be run to perform the task of training the speech recognition model, the task of training the image classification model and the task of training the text generation model. It may take 100 learning periods to perform the task of training the speech recognition model. In the 101^{st} learning period, the task of training the speech recognition model has ended, and the task of training the image classification model and the task of training the text generation model may be added.

In embodiments of the present disclosure, in a learning period, for a learning task, a device may train a model corresponding to the learning task for multiple times.

For example, in a learning period, for the task of training the speech recognition model, the device may train the speech recognition model five times. After the learning period ends, the speech recognition model obtained after the last training may be received as a trained speech recognition model.

In embodiments of the present disclosure, the resource information of the candidate device may be a device hardware resource.

For example, the resource information of the candidate device may include the number and utilization rate of CPU in the device, the number and utilization rate of GPU (Graphics Processing Unit), or a capacity of a memory. It may be understood that the above-mentioned resource information is only used as an example to facilitate the understanding of the present disclosure, which is not limited in the present disclosure.

In operation S220, a global model for each task is transmitted to the target device for the each task, so that the target device for the each task trains the global model for the each task.

In embodiments of the present disclosure, the target device for the each task may train the global model for the each task by using local raw data of the device.

For example, after receiving a global model for a task, a target device may select training data required to perform the task from the local raw data, input the training data into the global model for the task, and train the global model according to an output of the global model and a label of the training data.

In embodiments of the present disclosure, a target number of times that the target device for the each task trains the global model for the each task may be determined according to the resource information of the target device performing the each task.

For example, for a task, a target device has a large number of CPUs, then the target number of times that the target device trains the global model for the task may be determined to be 10; another target device has a small number of CPUs, then the target number of times that the other target device trains the global model for the task may be determined to be 5. The target number of times may be, for example, negatively related with the CPU utilization rate or positively related with the number of CPUs.

In embodiments of the present disclosure, after the target number of times is determined, the target number of times may be transmitted to the target device for the each task, so that the target device for the each task may train the global model for the each task according to the target number of times.

In operation S230, in response to receiving the trained models from all target devices for the each task, the global model for the each task is updated according to the trained models, so as to complete the current learning period.

For example, in the current learning period, a global speech recognition model may be updated according to trained speech recognition models, a global image classification model may be updated according to trained image classification models, and a global text generation model may be updated according to trained text generation models.

Through embodiments of the present disclosure, according to the method of federated learning, a plurality of tasks may be performed in parallel without waiting for each other. Before the model achieves an expected performance or a final stop condition is met, all steps except an initialization may be repeatedly performed for multiple periods. In the method of federated learning of embodiments of the present disclosure, an impact of a current scheduling scheme on other tasks is fully considered, and the device resource may be scheduled more reasonably for each task, so as to minimize a convergence time.

FIG. 3 shows a flowchart of determining the target device for the each task of the at least one learning task to be performed, from the plurality of candidate devices according to embodiments of the present disclosure.

As shown in FIG. 3, the method may be implemented to, for the current learning period, determine the target device for the each task of the at least one learning task to be performed, from the plurality of candidate devices according to the resource information of the plurality of candidate devices. This will be described in detail below through operation S311 to operation S315.

In operation S311, a target device set corresponding to a minimum time cost of the current learning period is determined as a candidate scheduling information according to the resource information of the plurality of candidate devices.

For example, the target device set may include at least one target device group for the at least one learning task respectively.

In embodiments of the present disclosure, K candidate devices are provided to constitute a candidate device set κ, expressed as {1, 2, . . . , K}. These candidate devices jointly participate in a model training for M different tasks, and the M different tasks constitute a task set, expressed as {1, 2, . . . , M}.

In embodiments of the present disclosure, a time length information for each candidate device of the plurality of candidate devices performing the each task may be determined according to the resource information of the plurality of candidate devices.

For example, a computation index of each candidate device may be determined according to the resource information of the each candidate device, and the computation index indicates a computation capacity of the each candidate device.

In some examples, the computation index of a k^{th} candidate device may include aₖ and μₖ. The computation index aₖ may be obtained by Equation (1).

aₖ=MAC/f (1)

where MAC is a hyper-parameter related to the number of weights of the model, for example, the MAC may be positively related to the number of weights, f represents a frequency of CPU, and the computation index aₖ is in unit of ms/sample.

The computation index μₖ and the computation index aₖ are reciprocal to each other.

For example, the time length information for each candidate device performing the each task may be determined by using a predetermined shift exponential distribution according to the computation index and a data amount of training data for the each task stored in the each candidate device.

In some examples, a time length information for a candidate device performing a task is determined by using a predetermined shift exponential distribution, and the predetermined shift exponential distribution may be expressed by Equation (2).

$$P [ {t}_{k , m}^{cp} < t ] = \{ \begin{matrix}1 - {e}^{- \frac{{μ}_{k}}{{τ}_{m} {D}_{k}^{m}} ( t - {τ}_{m} {a}_{k} {D}_{k}^{m} )} , & t \geq {τ}_{m} {a}_{k} {D}_{k}^{m} \\ 0 , & otherwise\end{matrix} \qquad ( 2 )$$

where P[t_{k,m}^{cp}<t] is a predetermined shift exponential distribution function, Dₖ^{m} represents a data amount of training data for an m^{th} task in a local database of the k^{th} candidate device, t represents the time length information, τₘ represents an epoch number of the device, which may be, for example, a hyper-parameter, where m≤M, and the k^{th} candidate device is one of the above-mentioned K candidate devices.

After the computation indexes aₖ and μₖ of the k^{th} candidate device, the data amount Dₖ^{m} of the training data for the m^{th} task and the epoch number τₘ of the device are determined, the time length information t may be determined through the predetermined shift exponential distribution function P[t_{k,m}^{cp}<t]. The time length information for each candidate device performing each task may be determined by similar means.

In embodiments of the present disclosure, the target device set corresponding to the minimum time cost of the current learning period may be determined according to the time length information.

For example, this embodiment may also be implemented to determine a scheduling balance variance of a plurality of candidate devices for each task according to a number of times that each candidate device performs the each task in a learning period prior to the current learning period.

In some examples, the scheduling balance variance of a candidate device for a task may be determined by Equation (3).

$$g ( {s}_{m} ) = \frac{1}{N} {{Σ}_{n = 0}^{N} ( {Q}_{m} [ n ] - \frac{1}{N} {Σ}_{n = 0}^{N} {Q}_{m} [ n ] )}^{2} \qquad ( 3 )$$

where g(sₘ) represents the scheduling balance variance, and Qₘ[n] is a set of size N. Qₘ[n] contains K data, and each data represents a number of times that a device is selected for first (Rₘ−1) learning periods of the m^{th} task. In an Rₘ^{th} learning period, a device group performing the m^{th} task may be represented by sₘ, for example. The scheduling balance variance of the plurality of candidate devices for each task may be determined by similar means.

For example, the target device set corresponding to the minimum time cost of the current learning period may be determined according to the scheduling balance variance and the time length information.

In some examples, for a task in the current period, a target device group s_{T} corresponding to the minimum time cost of the current learning period may be determined by Equation (4).

s_{T}=min{Σₛ_{ₘ}_{⊂S} max{t_{k,m}^{cm}+t_{k,m}^{cp}}+λₘg(sₘ)} (4)

where sₘ⊂κ, ∀m∈{1, 2, . . . , M}, sⱼ⊂S, S∈{s₁, s₂, . . . , s_{M}}, t_{k,m}^{cm} represents a communication time required for the k^{th} candidate device performing the m^{th} task in a training period, t_{k,m}^{cp} represents a computation period required for the k^{th} candidate device performing the m^{th} task in a training period, and λₘ is a hyper-parameter. In the same way, for other tasks in the current period, a plurality of target device groups corresponding to the minimum time cost of the current learning period may be determined by, for example, Equation (4). The plurality of target device groups may constitute a target device set. In a training period, one device is only assigned to perform one learning task.

This embodiment may use an idea of a greedy algorithm for reference to obtain an approximate solution corresponding to the minimum training time required for all tasks (such as the target device set) in the current learning period.

In embodiments of the present disclosure, operation S312 may be performed by using the candidate scheduling information and a plurality of predetermined scheduling information as an initial scheduling information set.

For example, the target device set may be used as a candidate scheduling information p_{T}, and the candidate scheduling information p_{T} is combined with n−1 randomly generated scheduling information to obtain n scheduling information, which constitute the initial scheduling information set, where n is a positive integer.

In operation S312, a target scheduling information in a current scheduling information set is adjusted to obtain n adjusted scheduling information.

In embodiments of the present disclosure, when the target scheduling information in the current scheduling information set is adjusted for a first time, a current scheduling information is the above-mentioned initial scheduling information.

In embodiments of the present disclosure, at least two scheduling information in the current scheduling information set are determined as the target scheduling information according to a time cost of the current learning period consumed by each scheduling information in the current scheduling information set.

For example, two scheduling information in the current scheduling information set may be determined as the target scheduling information. In some examples, the scheduling information p₁={k₁, k₂, k₃, k₄, k₅} and p₂={k₁, k₂, k₆, k₇, k₈} may be determined as the target scheduling information, where k₁, k₂, k₃, k₄, k₅, k₆, k₇, k₈ are all candidate devices in the device set κ.

For example, three scheduling information in the current scheduling information set may be determined as the target scheduling information. In some examples, the scheduling information p₁={k₁, k₂, k₃, k₄, k₅}, p₂={k₁, k₂, k₆, k₇, k₈} and p₃={k₁, k₃, k₆, k₇, k₉} may be determined as the target scheduling information.

For example, a fitness value fitness of the scheduling information may be calculated by Equation (5).

fitness=−Σₛ_{ₘ}_{∈S}{(max_{k∈s}_{^{m}}{tₖ^{cm}+tₖ^{cp}})+λₘg(sₘ)} (5)

Then, two scheduling information may be selected using a Roulette Wheel Selection according to the fitness value of each scheduling information. For example, the scheduling information p₁ and p₂ may be selected as the target scheduling information by using the Roulette Wheel Selection.

In embodiments of the present disclosure, any two scheduling information in the target scheduling information may be adjusted using a cross operation, so as to obtain two adjusted scheduling information.

For example, a plurality of target devices may be obtained after a difference set of candidate devices in any two scheduling information is determined.

In some examples, a difference between the scheduling information p₁={k₁, k₂, k₃, k₄, k₅} and the scheduling information p₂={k₁, k₂, k₆, k₇, k₈} may be determined, and then six target devices k₃, k₄, k₅, k₆, k₇, k₈ may be determined.

For example, any two scheduling information in the target scheduling information may be adjusted using the cross operation according to the plurality of target devices.

In some examples, the scheduling information p₁={k₁, k₂, k₃, k₄, k₅} and the scheduling information p₂={k₁, k₂, k₆, k₇, k₈} may be adjusted using the cross operation according to the target devices k₃, k₄, k₅, k₆, k₇, k₈, so as to obtained the adjusted scheduling information. The adjusted scheduling information may be p′₁={k₁, k₂, k₃, k₄, k₆} and p′₂={k₁, k₂, k₅, k₇, k₈}.

In operation S313, n scheduling information corresponding to a large time cost of the current learning period is removed from the n adjusted scheduling information and the current scheduling information set, so as to obtain an updated scheduling information set.

For example, two scheduling information may be removed from the two adjusted scheduling information p′₁ and p′₂ and n current scheduling information, so as to obtain the updated scheduling information set. The updated scheduling information set contains n scheduling information.

In some examples, the scheduling information may be removed according to the fitness value. For example, two scheduling information with smallest fitness values may be removed.

In operation S314, it is determined whether a predetermined cycle stop condition is met. If it is determined that the predetermined cycle stop condition is not met, the process may return to the above-mentioned operation S312; or if it is determined that the predetermined cycle stop condition is met, operation S315 may be performed.

In embodiments of the present disclosure, the predetermined cycle stop condition may be that a fitness value of a scheduling information in the updated scheduling information set reaches a preset value.

In operation S315, the target device for the each task in the at least one learning task to be performed is output.

For example, after the above-mentioned operations S312 to S313 are cyclically performed for multiple times, if a fitness value of a scheduling information in the current scheduling information reaches the preset value, the cycle may be stopped, and a scheduling information with a largest fitness value in the current scheduling information may be output. The scheduling information with the largest fitness value contains the target device for the each task in the at least one learning task to be performed.

Using an idea of a genetic algorithm for reference, the technical solution of this embodiment may be implemented to search a large and complex scheduling information set and provide a plurality of satisfactory scheduling information sets. This embodiment may promote, through a finite number of cycles, an evolution of the current scheduling information set to a scheduling information set that meets a condition.

In some embodiments, the learning period for the method of federated learning may be determined by Equation (6).

$$\frac{1}{{β}_{m}^{0} {R}_{m} + {β}_{m}^{1}} + {β}_{m}^{2} \leq {1}_{m} \qquad ( 6 )$$

where βₘ⁰, βₘ¹ and βₘ² are hyper-parameters representing convergence curves of a task in, lₘ represents a preset loss value, and Rₘ represents the number of learning periods required to achieve the preset loss value lₘ. In a case that βₘ⁰, βₘ¹, βₘ² and lₘ are determined, Rₘ may be determined. According to the Rₘ, the number of learning periods for each learning task may be determined. In this way, this embodiment may be implemented to determine the number of learning periods required for each learning task in a plurality of learning tasks in Federated learning.

According to embodiments of the present disclosure, when the number of learning periods for a learning task reaches the required number of learning periods, the learning task to be performed may not include the learning task in a subsequent learning period.

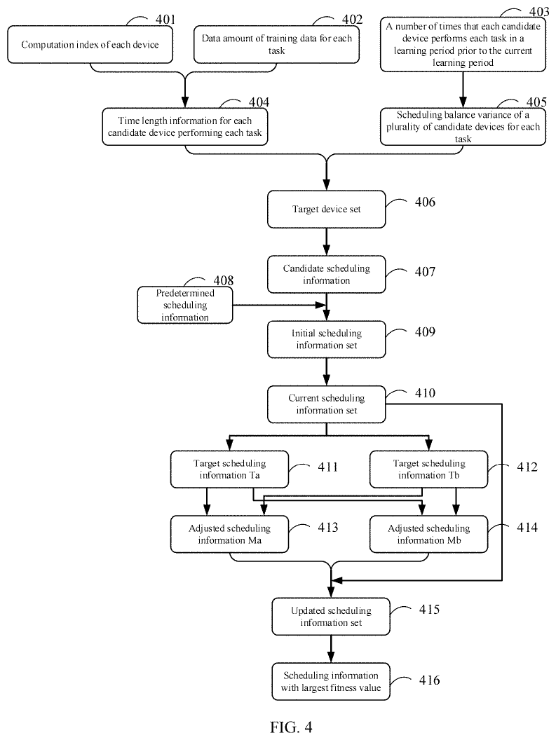

FIG. 4 shows a schematic diagram of a transfer learning method according to embodiments of the present disclosure.

As shown in FIG. 4, a time length information 404 for each candidate device performing each task may be determined by using, for example, Equation (2), according to a computation index 401 of the each candidate device and a data amount 402 of training data for the each task stored in the each candidate device.

At the same time, a scheduling balance variance 405 of a plurality of candidate devices for the each task may be determined by using, for example, Equation (3), according to a number of times 403 that each candidate device performs the each task 403 in a learning period prior to the current learning period.

Next, a plurality of target device groups for the each task may be determined by using, for example, Equation (4), according to the time length information 404 for each candidate device performing the each task and the scheduling balance variance 405 of the plurality of candidate devices for the each task. A combination of the plurality of target device groups is a target device set 406. The target device set 406 may correspond to the minimum time cost of the current learning period.

The target device set 406 may be used as a candidate scheduling information 407. Then, an initial scheduling information set 409 may be obtained according to the candidate scheduling information 407 and a predetermined scheduling information 408.

Next, a cycle operation is performed until a predetermined cycle stop condition is met. In a process of a first cycle, the initial scheduling information set 409 is a current scheduling information set 410.

In one cycle operation, at least two scheduling information, for example, including a target scheduling information Ta 411 and a target scheduling information Tb 412 in FIG. 4, may be selected from the current scheduling information set 410 as the target scheduling information. A difference set of the target scheduling information Ta 411 and the target scheduling information Tb 412 may be determined firstly to obtain a plurality of target devices. Then, the cross operation may be performed to adjust the two target scheduling information, for example, exchange one target device contained in the target scheduling information Ta 411 with another target device contained in the target scheduling information Tb 412, so as to obtain an adjusted scheduling information Ma 413 and an adjusted scheduling information Mb 414.

According to the fitness value of each scheduling information determined by using, for example, Equation (5), two scheduling information with smallest fitness values may be removed from the adjusted scheduling information Ma 413, the adjusted scheduling information Mb 414 and the current scheduling information set 410, so as to obtain an updated scheduling information set 415. The smaller the fitness value of the scheduling information, the larger the time cost of the current learning period.

In this embodiment, it is determined whether a scheduling information 416 with a largest fitness value in the updated scheduling information set 415 meets the predetermined cycle stop condition. If the predetermined cycle stop condition is met, the scheduling information 416 with the largest fitness value may be output as an output result. If the predetermined cycle stop condition is not met, the above-mentioned operations may be repeatedly performed using the updated scheduling information set 415 as the current scheduling information set 410, until the predetermined cycle stop condition is met.

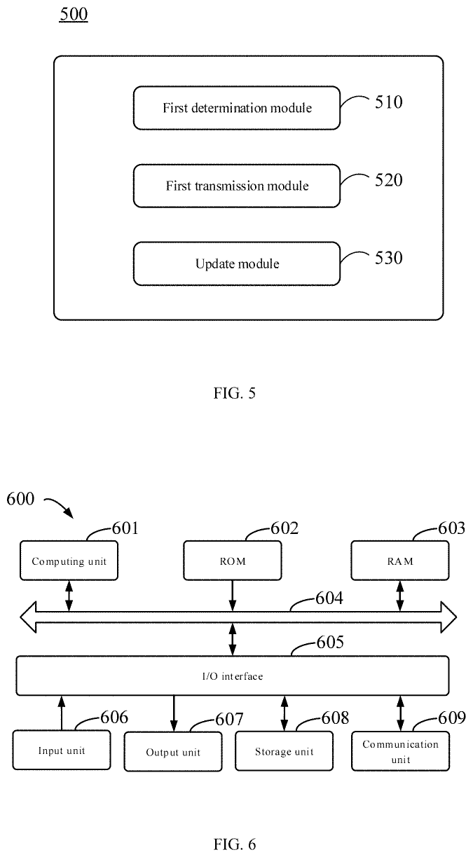

Based on the method of federated learning provided by the present disclosure, the present disclosure further provides an apparatus of federated learning. The apparatus will be described in detail below with reference to FIG. 5.

FIG. 5 shows a structural block diagram of an apparatus of federated learning according to embodiments of the present disclosure.

As shown in FIG. 5, an apparatus 500 includes a first determination module 510, a first transmission module 520, and an update module 530.

The first determination module 510 is used to determine, for a current learning period, a target device for each task of at least one learning task to be performed, from a plurality of candidate devices according to a plurality of resource information of the plurality of candidate devices. In some embodiments, the first determination module 510 may be used to perform the operation S210 described above, which will not be repeated here.

The first transmission module 520 is used to transmit a global model for the each task to the target device for the each task, so that the target device for the each task trains the global model for the each task. In some embodiments, the first transmission module 520 may be used to perform the operation S220 described above, which will not be repeated here.

The update module 530 is used to update, in response to receiving trained models from all target devices for the each task, the global model for the each task according to the trained models, so as to complete the current learning period. In some embodiments, the update module 530 may be used to perform the operation S230 described above, which will not be repeated here.

In some embodiments, the first determination module includes: a first determination sub-module used to determine a target device set corresponding to a minimum time cost of the current learning period as a candidate scheduling information, according to the resource information of the plurality of candidate devices, the target device set includes a plurality of target device groups for at least one learning task respectively; and a cycle sub-module used to cyclically perform operations by using the candidate scheduling information and a plurality of predetermined scheduling information as an initial scheduling information set until a predetermined cycle stop condition is met, the operations are performed by: an adjustment unit used to adjust a target scheduling information in a current scheduling information set to obtain n adjusted scheduling information, where n is a positive integer; and a remove unit used to remove n scheduling information corresponding to a large time cost of the current learning period from the n adjusted scheduling information and the current scheduling information set, so as to obtain an updated scheduling information set.

In some embodiments, the second determination sub-module includes: a first determination unit used to determine, according to the resource information of the plurality of candidate devices, a time length information for each candidate device of the plurality of candidate devices performing the each task; and a second determination unit used to determine the target device set corresponding to the minimum time cost of the current learning period, according to the time length information.

In some embodiments, the second determination unit includes: a first determination sub-unit used to determine a scheduling balance variance of the plurality of candidate devices for the each task according to a number of times that the each candidate device performs the each task in a learning period prior to the current learning period; and a second determination sub-unit used to determine the target device set corresponding to the minimum time cost of the current learning period, according to the scheduling balance variance and the time length information.

In some embodiments, the first determination unit includes: a third determination sub-unit used to determine a computation index of the each candidate device according to the resource information of the each candidate device, the computation index indicates a computation capacity of the each candidate device; and an execution sub-unit used to determine, by using a predetermined shift exponential distribution, the time length information for the each candidate device performing the each task, according to the computation index and a data amount of training data for the each task stored in the each candidate device.

In some embodiments, the adjustment unit includes: a fourth determination sub-unit used to determine at least two scheduling information in the current scheduling information set as at least two target scheduling information, according to the time cost of the current learning period consumed by each scheduling information in the current scheduling information set; and a first adjustment sub-unit used to adjust any two scheduling information in the target scheduling information by using a cross operation, so as to obtain two adjusted scheduling information.

In some embodiments, the first adjustment sub-unit includes: a fifth determination sub-unit used to determine a difference set of candidate devices in the two scheduling information to obtain a plurality of target devices; and a second adjustment sub-unit used to adjust the two scheduling information in the target scheduling information by using the cross operation according to the plurality of target devices.

In some embodiments, the apparatus 500 may further include: a second determination module used to determine a target number of times that the target device for the each task trains the global model for the each task, according to the resource information of the target device performing the each task; and a second transmission module used to transmit the target number of times to the target device for the each task, so that the target device for the each task trains the global model for the each task according to the target number of times.

It should be noted that in the technical solution of the present disclosure, an acquisition, a collection, a storage, an application, a processing, a transmission, a provision and a disclosure of user personal information involved comply with provisions of relevant laws and regulations, and do not violate public order and good custom.

According to embodiments of the present disclosure, the present disclosure further provides an electronic device, a readable storage medium, and a computer program product.

FIG. 6 shows a schematic block diagram of an exemplary electronic device 600 for implementing the method of federated learning of embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and processes described above, such as the method of federated learning. For example, in some embodiments, the method of federated learning may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method of federated learning described above. Alternatively, in other embodiments, the computing unit 601 may be used to perform the method of federated learning by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak business scalability existing in a traditional physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of federated learning, comprising:
determining, for a current learning period, a target device for each task of at least one learning task to be performed, from a plurality of candidate devices according to a plurality of resource information of the plurality of candidate devices;
transmitting a global model for the each task to the target device for the each task, so that the target device for the each task trains the global model for the each task; and
updating, in response to receiving trained models from all target devices for the each task, the global model for the each task according to the trained models, so as to complete the current learning period.

2. The method of claim 1, wherein the determining a target device for each task of at least one learning task to be performed, from a plurality of candidate devices comprises:
determining a target device set corresponding to a minimum time cost of the current learning period as a candidate scheduling information, according to the resource information of the plurality of candidate devices, wherein the target device set comprises a plurality of target device groups for at least one learning task respectively; and
cyclically performing operations by using the candidate scheduling information and a plurality of predetermined scheduling information as an initial scheduling information set until a predetermined cycle stop condition is met, wherein the operations comprise:
adjusting a target scheduling information in a current scheduling information set to obtain n adjusted scheduling information, where n is a positive integer; and
removing n scheduling information corresponding to a large time cost of the current learning period from the n adjusted scheduling information and the current scheduling information set, so as to obtain an updated scheduling information set.

3. The method of claim 2, wherein the determining a target device set corresponding to a minimum time cost of the current learning period comprises:
determining, according to the resource information of the plurality of candidate devices, a time length information for each candidate device of the plurality of candidate devices performing the each task; and
determining the target device set corresponding to the minimum time cost of the current learning period, according to the time length information.

4. The method of claim 3, wherein the determining a target device set corresponding to a minimum time cost of the current learning period comprises:
determining a scheduling balance variance of the plurality of candidate devices for the each task according to a number of times that the each candidate device performs the each task in a learning period prior to the current learning period; and
determining the target device set corresponding to the minimum time cost of the current learning period, according to the scheduling balance variance and the time length information.

5. The method of claim 3, wherein the determining a time length information for each candidate device of the plurality of candidate devices performing the each task comprises:
determining a computation index of the each candidate device according to the resource information of the each candidate device, wherein the computation index indicates a computation capacity of the each candidate device; and
determining, by using a predetermined shift exponential distribution, the time length information for the each candidate device performing the each task, according to the computation index and a data amount of training data for the each task stored in the each candidate device.

6. The method of claim 2, wherein the adjusting a target scheduling information in a current scheduling information set comprises:
determining at least two scheduling information in the current scheduling information set as at least two target scheduling information, according to the time cost of the current learning period consumed by each scheduling information in the current scheduling information set; and
adjusting any two scheduling information in the target scheduling information by using a cross operation, so as to obtain two adjusted scheduling information.

7. The method of claim 6, wherein the adjusting any two scheduling information in the target scheduling information by using a cross operation comprises:
determining a difference set of candidate devices in the two scheduling information to obtain a plurality of target devices; and
adjusting the two scheduling information in the target scheduling information by using the cross operation according to the plurality of target devices.

8. The method of claim 1, further comprising:
determining a target number of times that the target device for the each task trains the global model for the each task, according to the resource information of the target device performing the each task; and
transmitting the target number of times to the target device for the each task, so that the target device for the each task trains the global model for the each task according to the target number of times.

9. An electronic device, comprising:
at least one processor; and
a memory communicatively connected to the at least one processor, wherein the memory stores instructions executable by the at least one processor, and the instructions, when executed by the at least one processor, cause the at least one processor to implement operations of federated learning, comprising:
determining, for a current learning period, a target device for each task of at least one learning task to be performed, from a plurality of candidate devices according to a plurality of resource information of the plurality of candidate devices;
transmitting a global model for the each task to the target device for the each task, so that the target device for the each task trains the global model for the each task; and
updating, in response to receiving trained models from all target devices for the each task, the global model for the each task according to the trained models, so as to complete the current learning period.

10. The electronic device of claim 9, wherein the instructions, when executed by the at least one processor, cause the at least one processor further to implement operations of:
determining a target device set corresponding to a minimum time cost of the current learning period as a candidate scheduling information, according to the resource information of the plurality of candidate devices, wherein the target device set comprises a plurality of target device groups for at least one learning task respectively; and
cyclically performing operations by using the candidate scheduling information and a plurality of predetermined scheduling information as an initial scheduling information set until a predetermined cycle stop condition is met, wherein the operations comprise:
adjusting a target scheduling information in a current scheduling information set to obtain n adjusted scheduling information, where n is a positive integer; and
removing n scheduling information corresponding to a large time cost of the current learning period from the n adjusted scheduling information and the current scheduling information set, so as to obtain an updated scheduling information set.

11. The electronic device of claim 10, wherein the instructions, when executed by the at least one processor, cause the at least one processor further to implement operations of:
determining, according to the resource information of the plurality of candidate devices, a time length information for each candidate device of the plurality of candidate devices performing the each task; and
determining the target device set corresponding to the minimum time cost of the current learning period, according to the time length information.

12. The electronic device of claim 11, wherein the instructions, when executed by the at least one processor, cause the at least one processor further to implement operations of:
determining a scheduling balance variance of the plurality of candidate devices for the each task according to a number of times that the each candidate device performs the each task in a learning period prior to the current learning period; and
determining the target device set corresponding to the minimum time cost of the current learning period, according to the scheduling balance variance and the time length information.

13. The electronic device of claim 11, wherein the instructions, when executed by the at least one processor, cause the at least one processor further to implement operations of:
determining a computation index of the each candidate device according to the resource information of the each candidate device, wherein the computation index indicates a computation capacity of the each candidate device; and
determining, by using a predetermined shift exponential distribution, the time length information for the each candidate device performing the each task, according to the computation index and a data amount of training data for the each task stored in the each candidate device.

14. The electronic device of claim 10, wherein the instructions, when executed by the at least one processor, cause the at least one processor further to implement operations of:
determining at least two scheduling information in the current scheduling information set as at least two target scheduling information, according to the time cost of the current learning period consumed by each scheduling information in the current scheduling information set; and
adjusting any two scheduling information in the target scheduling information by using a cross operation, so as to obtain two adjusted scheduling information.

15. The electronic device of claim 14, wherein the instructions, when executed by the at least one processor, cause the at least one processor further to implement operations of:
determining a difference set of candidate devices in the two scheduling information to obtain a plurality of target devices; and
adjusting the two scheduling information in the target scheduling information by using the cross operation according to the plurality of target devices.

16. The electronic device of claim 9, wherein the instructions, when executed by the at least one processor, cause the at least one processor further to implement operations of:
determining a target number of times that the target device for the each task trains the global model for the each task, according to the resource information of the target device performing the each task; and
transmitting the target number of times to the target device for the each task, so that the target device for the each task trains the global model for the each task according to the target number of times.

17. A non-transitory computer-readable storage medium having computer instructions therein, wherein the computer instructions are configured to cause a computer to implement operations of federated learning, comprising:
determining, for a current learning period, a target device for each task of at least one learning task to be performed, from a plurality of candidate devices according to a plurality of resource information of the plurality of candidate devices;
transmitting a global model for the each task to the target device for the each task, so that the target device for the each task trains the global model for the each task; and
updating, in response to receiving trained models from all target devices for the each task, the global model for the each task according to the trained models, so as to complete the current learning period.

18. The storage medium of claim 17, wherein the computer instructions are configured to cause the computer further to implement operations of:
determining a target device set corresponding to a minimum time cost of the current learning period as a candidate scheduling information, according to the resource information of the plurality of candidate devices, wherein the target device set comprises a plurality of target device groups for at least one learning task respectively; and
cyclically performing operations by using the candidate scheduling information and a plurality of predetermined scheduling information as an initial scheduling information set until a predetermined cycle stop condition is met, wherein the operations comprise:
adjusting a target scheduling information in a current scheduling information set to obtain n adjusted scheduling information, where n is a positive integer; and
removing n scheduling information corresponding to a large time cost of the current learning period from the n adjusted scheduling information and the current scheduling information set, so as to obtain an updated scheduling information set.

19. The storage medium of claim 18, wherein the computer instructions are configured to cause the computer further to implement operations of:
determining, according to the resource information of the plurality of candidate devices, a time length information for each candidate device of the plurality of candidate devices performing the each task; and
determining the target device set corresponding to the minimum time cost of the current learning period, according to the time length information.

20. The storage medium of claim 19, wherein the computer instructions are configured to cause the computer further to implement operations of:
determining a scheduling balance variance of the plurality of candidate devices for the each task according to a number of times that the each candidate device performs the each task in a learning period prior to the current learning period; and
determining the target device set corresponding to the minimum time cost of the current learning period, according to the scheduling balance variance and the time length information.
